(19) United States
(12) Patent Application Publication
(10) Pub. No.: US 2016/0318372 A1
(43) Pub. Date: Nov. 3, 2016

(54) SYSTEM AND METHOD FOR CONTROLLING AIR CONDITIONER FOR VEHICLE

(71) Applicants: Hyundai Motor Company, Seoul (KR); Kia Motors Corporation, Seoul (KR); Hanon Systems, Daejeon (KR)

(72) Inventors: Myung Hun KANG, Jeonju-si (KR); Sang Shin LEE, Suwon-si (KR); Sang Yeop LEE, Gunsan-si (KR); Myung Hoe KIM, Seoul (KR); Jae Woo KO, Daejeon (KR); Gyu Ik HAN, Daejeon (KR)

(73) Assignees: Hyundai Motor Company, Seoul (KR); Kia Motors Corporation, Seoul (KR); Hanon Systems, Daejeon (KR)

(21) Appl. No.: 14/966,381

(22) Filed: Dec. 11, 2015

(30) Foreign Application Priority Data
Apr. 28, 2015 (KR) 10-2015-0059534

(51) Int. Cl. B60H 1/00

(52) U.S. Cl. CPC B60H 1/00864; B60H 1/00828; B60H 1/00835

(57) ABSTRACT

A system for controlling an air conditioner for a vehicle may include a drive only mode selector configured to select a whole air-conditioning mode or an individual air-conditioning mode, a blower motor configured to provide different volumes of air indoors in the whole air-conditioning mode or the individual air-conditioning mode, a passenger seat mode door configured to be opened by an actuator when the whole air-conditioning mode is selected, and to be closed by the actuator when the individual air-conditioning mode is selected, and a controller configured to control a speed at which the voltage of the blower motor is decreased, or to control a speed at which the voltage of the blower motor is increased.

### CROSS-REFERENCE TO RELATED APPLICATION

The present application claims priority to Korean Patent Application No. 10-2015-0059534 filed Apr. 28, 2015, the entire contents of which is incorporated herein for all purposes by this reference.

### BACKGROUND OF THE INVENTION

1. Field of the Invention

The present invention relates to a system and a method for controlling an air conditioner for a vehicle. More particularly, it relates to a system and a method for controlling an air conditioner for a vehicle, which can prevent a foreign feeling for the volume of discharge air, which a driver feels due to an instantaneous change in air discharged to the interior of the vehicle in a switch between a whole air-conditioning mode and an individual air-conditioning mode.

2. Description of Related Art

An air conditioner for a vehicle is one of convenience devices absolutely necessary for the vehicle, which perform a function of adjusting the indoor temperature of the vehicle to a desired level according to an outdoor condition such as a winter time or a summer time, a function of removing moisture or ice formed on front glass, and the like.

A recent air conditioner mounted in a vehicle includes not only a whole air-conditioning operation function of simultaneously discharging discharge air toward a driver's seat and a passenger seat but also an individual air-conditioning operation function of selectively discharging the discharge air toward the driver's seat or the passenger seat.

FIG. 1 illustrates a whole air-conditioning operation state of an air conditioner for a vehicle, and FIG. 2 illustrates an individual air-conditioning operation state of the air conditioner.

In FIGS. 1 and 2, reference numeral 10 designates a blower motor for providing discharge air.

The blower motor 10 is disposed at one position of an air conditioner assembly, and a driver's seat mode door 11 and a passenger seat mode door 12 are openably/closably mounted at the other side of the air conditioner assembly. Also, an actuator 13 for opening/closing the passenger seat mode door 12 is connected to an opening/closing rotary shaft of the passenger seat mode door 12.

If a drive only mode switch of an air conditioner control panel disposed at the front of a driver's seat is turned off, as shown in FIG. 1, a whole air-conditioning mode is performed in which air discharged by an operation of the blower motor 10 is penetrated through the driver's seat mode door 11 and the passenger seat mode door 12 and then supplied to the interior of the vehicle via a corresponding duct.

On the other hand, if a drive mode switch of the air conditioner control panel is turned on, the passenger seat mode door 12 is in a close state according to an operation of the actuator 13, so that, as shown in FIG. 2, an individual air-conditioning mode is performed in which the air discharged by the operation of the blower motor 10 is penetrated through only the driver's seat mode door 11 and then supplied to the interior of the vehicle.

The individual air-conditioning mode decreases the air discharged by the operation of the blower motor 10 to a half level as compared with the whole air-conditioning mode, and fuel efficiency can be improved.

However, a switch between conventional individual and whole air-conditioning modes has problems as follows.

In Individual Air-Conditioning Mode

FIG. 3 illustrates an operation flowchart of a conventional individual air-conditioning mode, and FIG. 4 illustrates changes in voltage of the actuator and the blower motor in the individual air-conditioning mode.

In order to implement the individual air-conditioning mode, if the drive only mode switch of the air conditioner control panel is turned on, the passenger seat mode door is gradually closed according to the operation of the actuator, and simultaneously, the operating voltage of the blower motor is instantaneously decreased as compared with the whole air-conditioning mode so as to constantly maintain the volume of air discharged toward the driver's seat.

In this instance, the voltage of the blower motor is instantaneously decreased as shown in FIG. 4. On the other hand, the operating voltage of the actuator is gradually decreased as shown in FIG. 4.

That is, the voltage of the blower motor is instantaneously decreased such that the volume of the discharge air is concentrated toward the driver's seat as the passenger seat mode door is closed. On the other hand, the operating voltage of the actuator is gradually decreased because it takes a certain time (2 to 5 seconds) until the passenger seat mode door is fully closed.

As the operating voltage of the blower motor is instantaneously decreased as described above, the volume of air discharged toward the driver's seat is instantaneously decreased, and therefore, a driver feels a foreign feeling for the instantaneous decrease in the volume of air. If the passenger seat mode door is fully closed, the driver is adapted to the instantaneous decrease in the volume of air and feels that the volume of air is normal.

As a result, there is a problem in that, in the individual air-conditioning mode, the driver feels a foreign feeling as if the volume of air was instantaneously decreased and then returned to the normal volume of air.

In Whole Air-Conditioning Mode

FIG. 5 is an operation flowchart of a convention whole air-conditioning mode. FIG. 6 is a graph illustrating changes in voltage of the actuator and the blower motor in the whole air-conditioning mode.

In order to implement the whole air-conditioning mode, if the drive only mode switch of the air conditioner control panel is turned off, the passenger seat mode door is gradually opened according to the operation of the actuator, and simultaneously, the operating voltage of the blower motor is instantaneously increased as compared with the whole air-conditioning mode so as to allow discharge air to be simultaneously discharged toward the driver's seat and the passenger seat.

In this instance, the voltage of the blower motor is instantaneously increased as shown in FIG. 6. On the other hand, the operating voltage of the actuator is gradually increased as shown in FIG. 6.

That is, the voltage of the blower motor is instantaneously increased such that the discharge air is simultaneously discharged toward the driver's seat and the passenger seat as the passenger seat mode door is opened. On the other hand, the operating voltage of the actuator is gradually increased because it takes a certain time (2 to 5 seconds) until the passenger seat mode door is fully opened.

As the operating voltage of the blower motor is instantaneously decreased as described above, the volume of air discharged toward the driver's seat is instantaneously increased, and therefore, a driver feels a foreign feeling for the instantaneous increase in the volume of air. If the passenger seat mode door is fully opened, the driver is adapted to the instantaneous increase in the volume of air and feels that the volume of air is normal.

As a result, there is a problem in that, in the whole air-conditioning mode, the driver feels a foreign feeling as if the volume of air was instantaneously increased and then returned to the normal volume of air.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a system and a method for controlling an air conditioner for a vehicle, in which, in a switch between a whole air-conditioning mode and an individual air-conditioning mode, the speed at which the voltage of a blower motor is changed is controlled similarly to the speed at which the operating voltage of an actuator for driving a passenger seat mode door is changed, so that it is possible to reduce an instantaneous increase or decrease in the volume of air discharged to the interior of the vehicle, thereby preventing a foreign feeling for the volume of discharge air, which a driver feels.

According to various aspects of the present invention, a system for controlling an air conditioner for a vehicle may include a drive only mode selector configured to select a whole air-conditioning mode or an individual air-conditioning mode, a blower motor configured to provide different volumes of air indoors in the whole air-conditioning mode or the individual air-conditioning mode, a passenger seat mode door configured to be opened by an actuator when the whole air-conditioning mode is selected, and to be closed by the actuator when the individual air-conditioning mode is selected, and a controller configured to control a speed at which the voltage of the blower motor is decreased to follow a speed at which the operating voltage of the actuator for closing the passenger seat mode door is decreased when the individual air-conditioning mode is selected by the drive only mode selector, or to control a speed at which the voltage of the blower motor is increased to follow a speed at which the operating voltage of the actuator for opening the passenger seat mode door is increased when the whole air-conditioning mode is selected by the drive only mode selector.

According to various aspects of the present invention, a method for controlling an air conditioner for a vehicle may include selecting a whole air-conditioning mode or an individual air-conditioning mode, and when the whole air-conditioning mode or the individual air-conditioning mode is selected, controlling a speed at which the voltage of the blower motor for providing the volume of air is changed to a speed at which the operating voltage of the actuator for opening/closing the passenger seat mode door is changed.

When the individual air-conditioning mode is selected, the speed at which the voltage of the blower motor for providing the volume of air is decreased may be controlled to follow the speed at which the operating voltage of the actuator for closing the passenger seat mode door is decreased.

When the whole air-conditioning mode is selected, the speed at which the voltage of the blower motor for providing the volume of air is increased may be controlled to follow the speed at which the operating voltage of the actuator for opening the passenger seat mode door is increased.

The change in voltage of the blower motor may be controlled based on an equation of \sqrt{αVₘ}=ν_{c}(2A₀−A_{d} sin θ)=ν_{c}(2A₀−A_{d} sin βVₐ) which is a relationship between operating voltages of the actuator and voltages of the blower motor.

As described above, the present invention provides advantages as follows.

According to the present invention, in a switch between the whole air-conditioning mode and the individual air-conditioning mode of the air conditioner, the speed at which the voltage of the blower motor is changed is controlled similarly to the speed at which the operating voltage of the actuator for driving the passenger seat mode door, so that it is possible to reduce an instantaneous increase or decrease in the volume of air discharged to the interior of the vehicle, thereby preventing a foreign feeling for the volume of discharge air, which a driver feels.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a whole air-conditioning operation state of an air conditioner for a vehicle.

FIG. 2 is a schematic view illustrating an individual air-conditioning operation state of the air conditioner.

FIG. 3 is an operation flowchart of a conventional individual air-conditioning mode.

FIG. 4 is a graph illustrating changes in voltage of an actuator and a blower motor in the conventional individual air-conditioning mode.

FIG. 5 is an operation flowchart of a conventional whole air-conditioning mode.

FIG. 6 is a graph illustrating changes in voltage of the actuator and the blower motor in the conventional whole air-conditioning mode.

FIG. 7 is an operation flowchart of an individual air-conditioning mode according to the present invention.

FIG. 8 is a graph illustrating changes in voltage of an actuator and a blower motor in the individual air-conditioning mode according to the present invention.

FIG. 9 is an operation flowchart of a whole air-conditioning mode according to the present invention.

FIG. 10 is a graph illustrating changes in voltage of the actuator and the blower motor in the whole air-conditioning mode.

FIG. 11 and FIG. 12 are schematic views illustrating a relationship between operating voltages of the actuator and voltages of the blower motor.

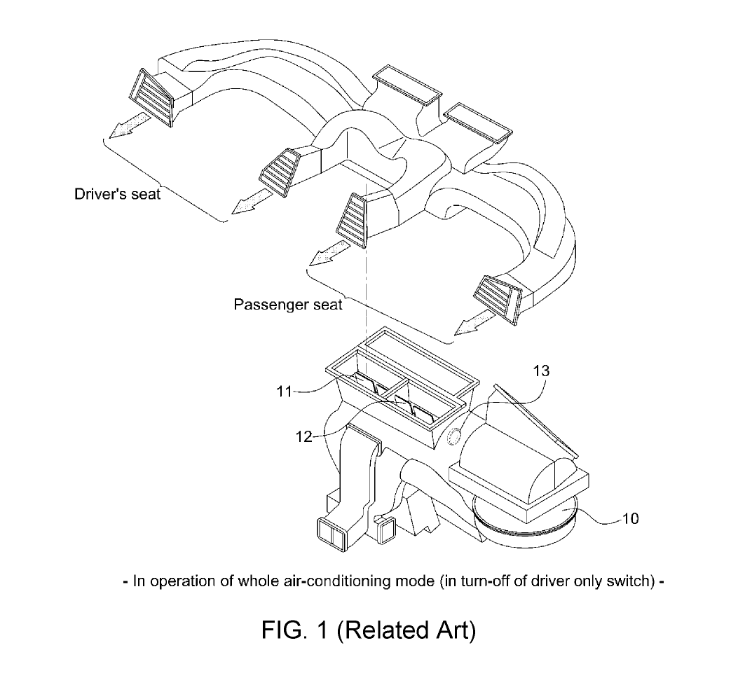

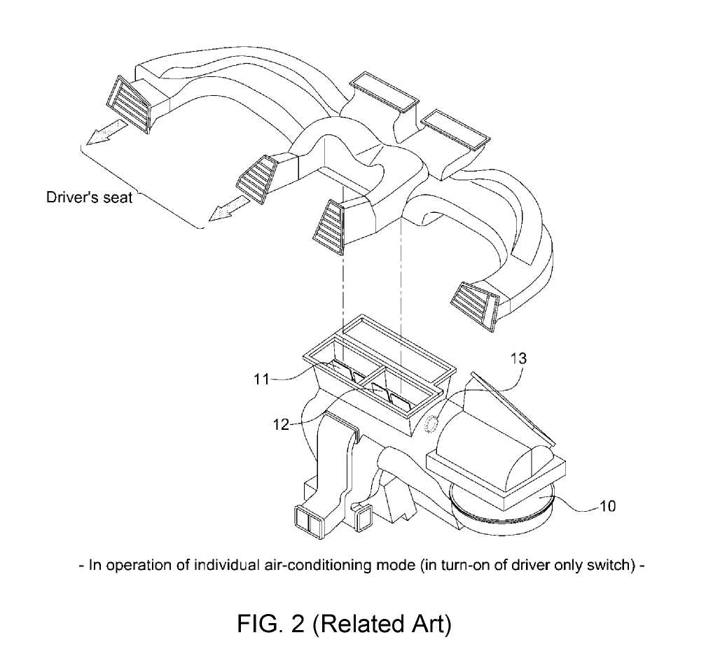

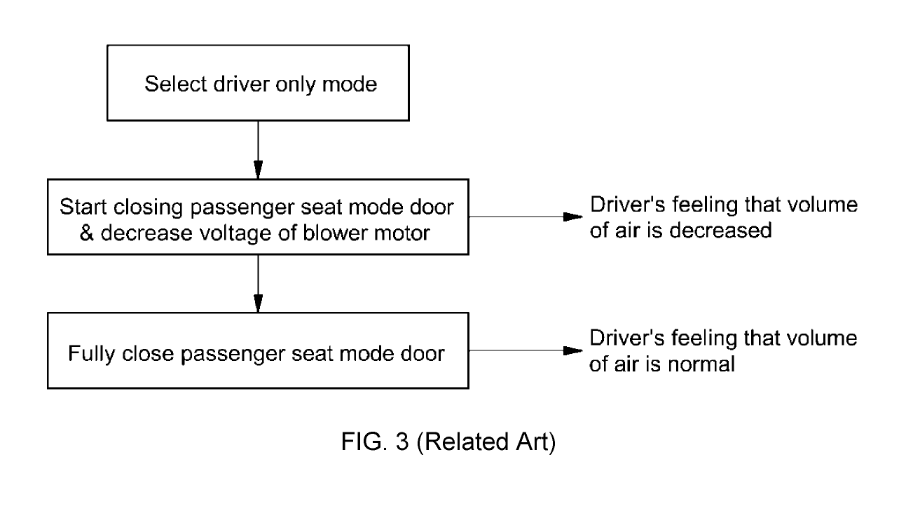

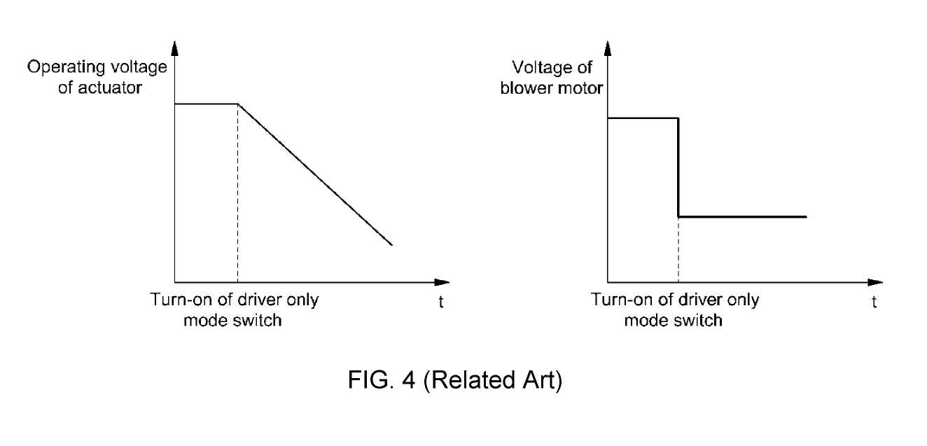

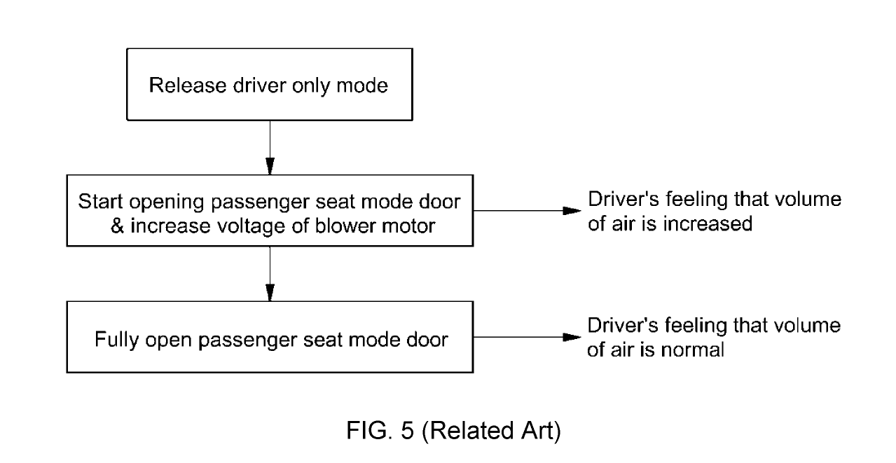

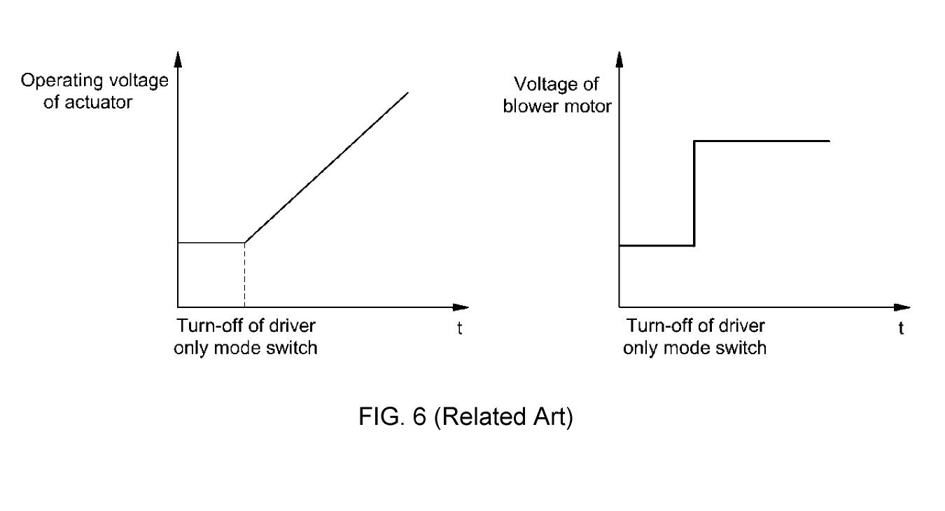

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In Individual Air-Conditioning Mode

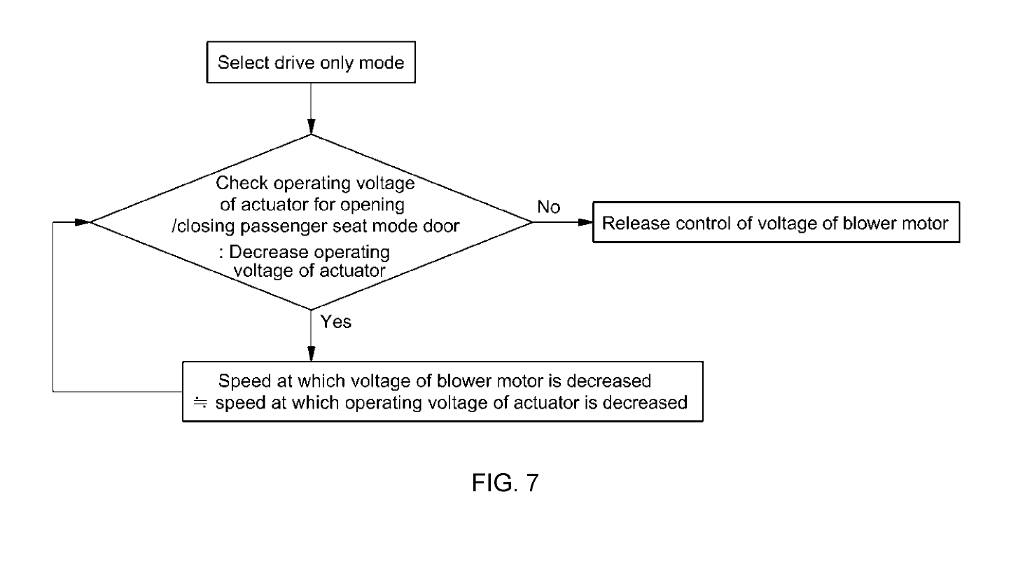

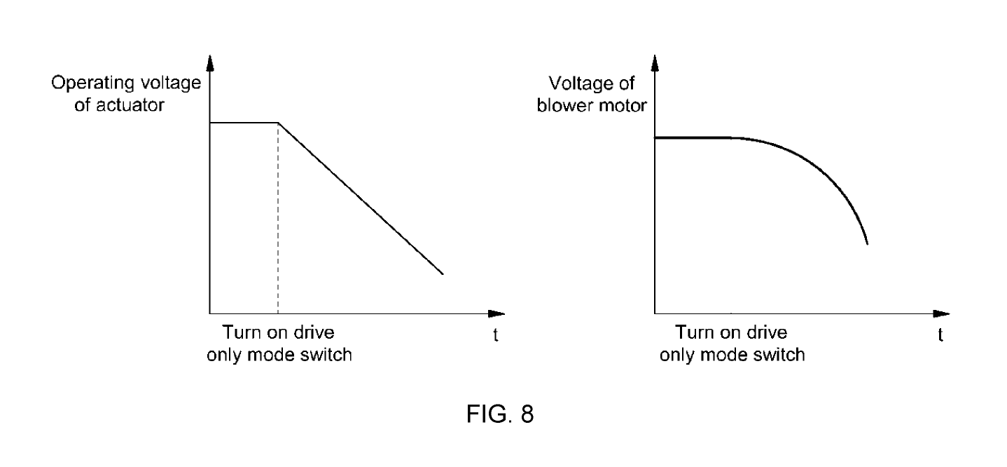

FIG. 7 is an operation flowchart of an individual air-conditioning mode according to an embodiment of the present invention. FIG. 8 illustrates changes in voltage of an actuator and a blower motor in the individual air-conditioning mode according to the embodiment of the present invention.

If a drive only mode switch of an air conditioner control panel disposed at the front of a driver's seat is turned on, the individual air-conditioning mode is performed in which a passenger seat mode door is in a close state according to an operation of the actuator, so that air discharged by an operation of the blower motor is penetrated through only a driver's seat mode door and discharged to the interior of a vehicle.

In this state, if a user (driver) turns on the drive only mode switch of the air conditioner control panel, a controller (e.g., a heater controller) controls a change in voltage such that the operating voltage of the actuator for opening/closing the passenger seat mode door is gradually decreased. Thus, the passenger seat mode door is gradually closed within the range of 2 to 5 seconds.

Simultaneously, as the passenger seat mode door is closed, the flow path area of the air toward the interior of the vehicle is decreased, and therefore, the controller decreases the voltage of the blower motor together with the operating voltage of the actuator so as to decrease the volume of air by the decreased flow path area. As shown in FIG. 8, the controller controls a speed at which the voltage of the blower motor is decreased to be similar to a speed at which the operating voltage of the actuator is decreased.

As such, when the individual air-conditioning mode is selected, the controller controls a speed at which the voltage of the blower motor for providing discharge air is decreased to follow a speed at which the operating voltage of the actuator for opening/closing the passenger seat mode door is decreased, so that the volume of air discharged to the interior of the vehicle through the driver's seat mode door is decreased at a slow speed. As a result, it is possible to remove a foreign feeling for the volume of air, which the driver feels as the volume of air is instantaneously decreased in the individual air-conditioning mode.

In Whole Air-Conditioning Mode

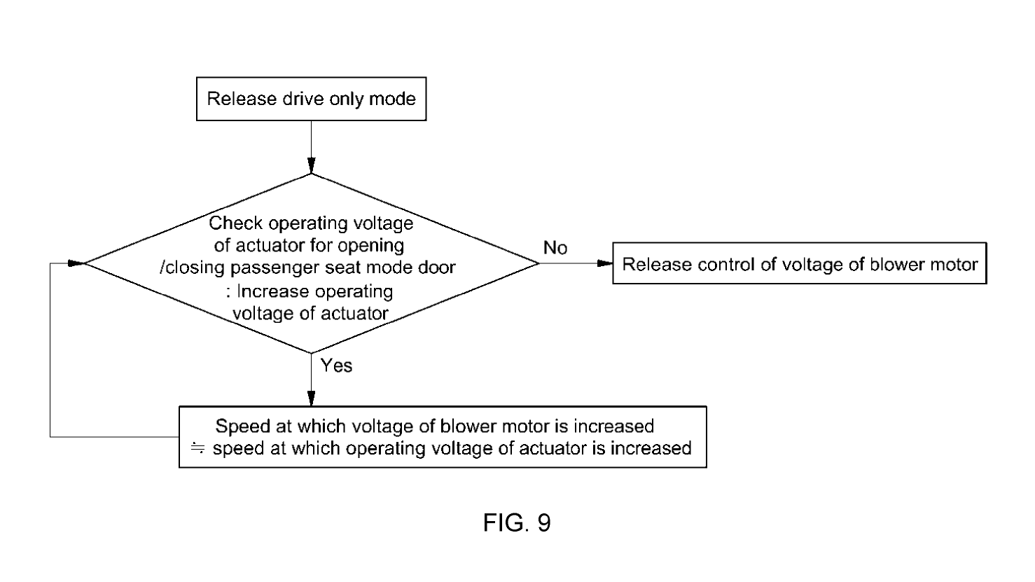

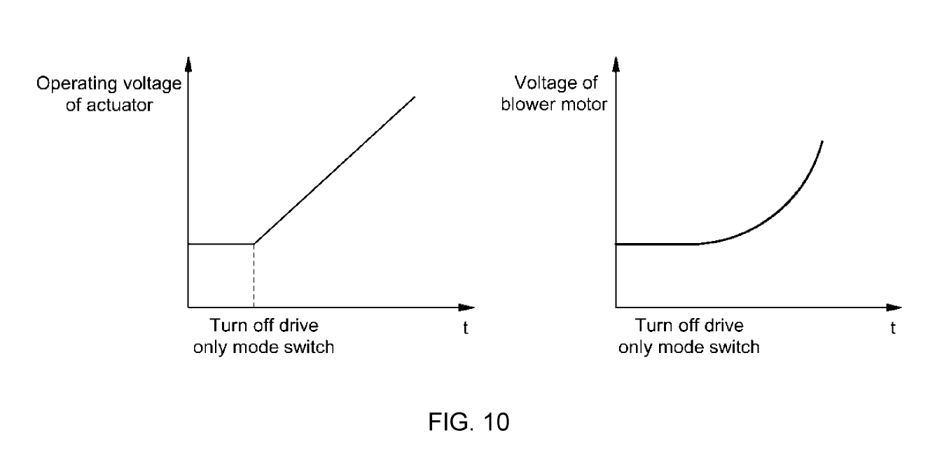

FIG. 9 is an operation flowchart of a whole air-conditioning mode according to various embodiments of the present invention. FIG. 10 illustrates changes in voltage of the actuator and the blower motor in the whole air-conditioning mode.

If the drive only mode switch of the air conditioner control panel disposed at the front of the driver's seat is turned off, the whole air-conditioning mode is performed in which air discharged by an operation of the blower motor is simultaneously penetrated through the driver's seat mode door and the passenger seat mode door and then supplied to the interior of the vehicle via a corresponding duct.

In this state, if the user (driver) turns off the drive only mode switch of the air conditioner control panel, the controller (e.g., the heater controller) controls a change in voltage such that the operating voltage of the actuator for opening/closing the passenger seat mode door is gradually increased. Thus, the passenger seat mode door is gradually opened within the range of 2 to 5 seconds.

Simultaneously, as the passenger seat mode door is opened, the flow path area of the air toward the interior of the vehicle is increased, and therefore, the controller increases the voltage of the blower motor together with the operating voltage of the actuator so as to increase the volume of air by the increased flow path area. As shown in FIG. 10, the controller controls a speed at which the voltage of the blower motor is increased to be similar to a speed at which the operating voltage of the actuator is increased.

As such, when the whole air-conditioning mode is selected, the controller controls a speed at which the voltage of the blower motor for providing discharge air is increased to follow a speed at which the operating voltage of the actuator of opening/closing the passenger seat mode door is increased, so that the volume of air discharged to the interior of the vehicle through the driver's seat mode door is increased at a slow speed. As a result, it is possible to remove a foreign feeling for the volume of air, which the driver feels as the volume of air is instantaneously increased in the whole air-conditioning mode.

Meanwhile, the controlling of the change in voltage of the blower motor to follow the change in operating voltage of the actuator is performed based on a relationship between operating voltages of the actuator and voltages of the blower motor.

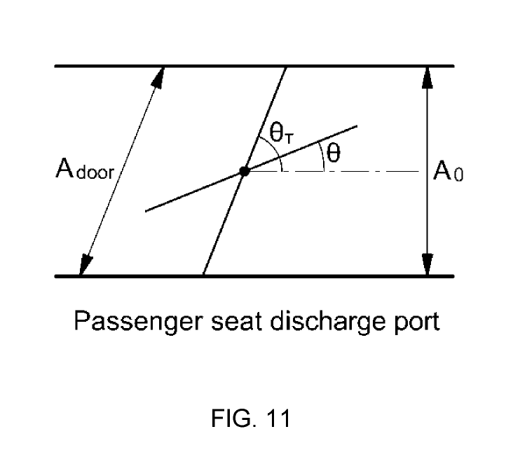

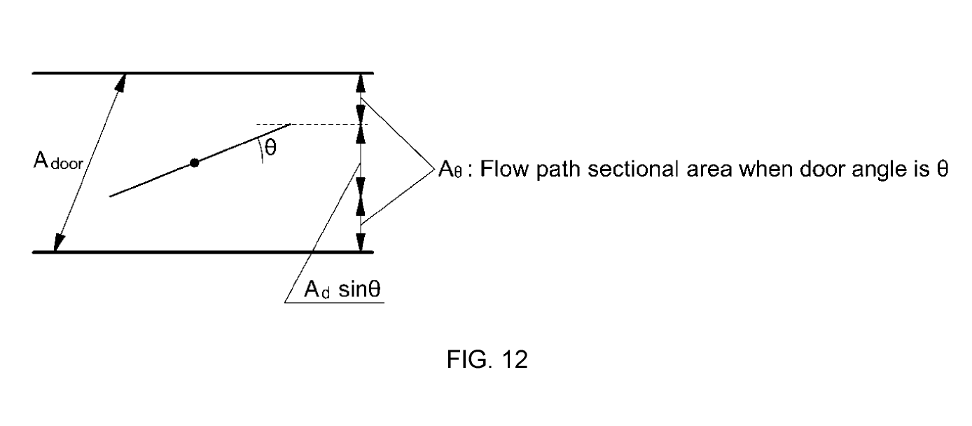

FIGS. 11 and 12 illustrate a relationship between operating voltages of the actuator and voltages of the blower motor, which show a passenger seat discharge port, and a passenger seat mode door attachably/detachably mounted therein.

In FIGS. 11 and 12, θT denotes an angle when the passenger seat mode door is fully closed, θ=βVa denotes a current angle of the passenger seat mode door (Va is an operating voltage of the actuator), Adoor=Ad denotes an area of the passenger seat mode door, A0=Ad sin θT denotes a flow path sectional area when the passenger seat mode door is fully opened, and Aθ=Apass denotes a flow path sectional area when the angle of the passenger seat mode door is θ.

Referring to FIG. 12 which illustrates Aθ(flow path sectional area when the angle of the passenger seat mode door is θ), Aθ may be expressed as Aθ=A0-Ad sin θ. Also, Aθ may be expressed as the following Equation 1.

Aθ=A0−Ad sin θ=Ad sin θT−Ad sin θ=Ad(sin θT−sin θ)=Apass Equation 1

Here, the speed of air discharged toward the driver's seat is to be constant such that the strength of the discharged air which the driver feels, i.e., the volume of the discharged air is constant. Accordingly, when the speed of air discharged toward the driver's seat is represented by Vc, the speed is volume of air/area. Therefore, the speed of air discharged toward the driver's seat is expressed as the following Equation 2.

$${υ}_{c} = \frac{Q}{A} = Const . \qquad Equation 2$$

In Equation 2, Q is the total volume of air discharged from the blower motor, and is expressed as a function of voltage applied to the blower motor. Therefore, the Q may be expressed as the following Equation 3. Also, A denotes a sum of a flow path sectional area for air discharged toward the driver's seat and a flow path sectional area for air discharged toward the passenger seat. Therefore, it may be expressed as the following Equation 4.

Q=\sqrt{αVₘ} Equation 3

In Equation 3, Vm denotes a voltage of the blower motor.

A=Adriver+Apass=A0+Ad(sin θT−sin θ) Equation 4

In Equation 4, Adriver is equal to A0 when it is considered that the passenger seat mode door is fully opened.

By combining Equations 3 and 4, a relationship between operating voltages of the actuator and voltages of the blower motor is derived as shown in Equations 5 and 6.

Q=ν_{c}A=ν_{c}(A_{driver}+Apass) Equation 5

\sqrt{αVₘ}=ν_{c}(2A₀−A_{d} sin θ)=ν_{c}(2A₀−A_{d} sin βVₐ) Equation 6

Thus, it is possible to easily control a change in voltage of the blower motor to follow a change in operating voltage of the actuator, based on the relationship between operating voltages of the actuator and voltages of the blower motor.

As described above, in a switch between the whole air-conditioning mode and the individual air-conditioning mode of the air conditioner, the speed at which the voltage of the blower motor is changed is controlled similarly to the speed at which the operating voltage of the actuator for driving the passenger seat mode door, so that it is possible to reduce an instantaneous increase or decrease in the volume of air discharged to the interior of the vehicle, thereby preventing a foreign feeling for the volume of discharge air, which a driver feels.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for controlling an air conditioner for a vehicle, the system comprising:
a drive only mode selector configured to select a whole air-conditioning mode or an individual air-conditioning mode;
a blower motor configured to provide different volumes of air indoors in the whole air-conditioning mode or the individual air-conditioning mode;
a passenger seat mode door configured to be opened by an actuator when the whole air-conditioning mode is selected, and to be closed by the actuator when the individual air-conditioning mode is selected; and
a controller configured to control a speed at which the voltage of the blower motor is decreased to follow a speed at which the operating voltage of the actuator for closing the passenger seat mode door is decreased when the individual air-conditioning mode is selected by the drive only mode selector, or to control a speed at which the voltage of the blower motor is increased to follow a speed at which the operating voltage of the actuator for opening the passenger seat mode door is increased when the whole air-conditioning mode is selected by the drive only mode selector.

2. A method for controlling an air conditioner for a vehicle, the method comprising:
selecting a whole air-conditioning mode or an individual air-conditioning mode; and
when the whole air-conditioning mode or the individual air-conditioning mode is selected, controlling a speed at which the voltage of the blower motor for providing the volume of air is changed to a speed at which the operating voltage of the actuator for opening/closing the passenger seat mode door is changed.

3. The method of claim 2, wherein, when the individual air-conditioning mode is selected, the speed at which the voltage of the blower motor for providing the volume of air is decreased is controlled to follow the speed at which the operating voltage of the actuator for closing the passenger seat mode door is decreased.

4. The method of claim 2, wherein, when the whole air-conditioning mode is selected, the speed at which the voltage of the blower motor for providing the volume of air is increased is controlled to follow the speed at which the operating voltage of the actuator for opening the passenger seat mode door is increased.

5. The method of claim 2, wherein the change in voltage of the blower motor is controlled based on an equation of \sqrt{αVₘ}=ν_{c}(2A₀−A_{d} sin θ)=ν_{c}(2A₀−A_{d} sin βVₐ) which is a relationship between operating voltages of the actuator and voltages of the blower motor.

6. The method of claim 3, wherein the change in voltage of the blower motor is controlled based on an equation of \sqrt{αVₘ}=ν_{c}(2A₀−A_{d} sin θ)=ν_{c}(2A₀−A_{d} sin βVₐ) which is a relationship between operating voltages of the actuator and voltages of the blower motor.

7. The method of claim 4, wherein the change in voltage of the blower motor is controlled based on an equation of \sqrt{αVₘ}=ν_{c}(2A₀−A_{d} sin θ)=ν_{c}(2A₀−A_{d} sin βVₐ) which is a relationship between operating voltages of the actuator and voltages of the blower motor.
